(19) United States
(12) Patent Application Publication
(10) Pub. No.: US 2010/0183909 A1
(43) Pub. Date: Jul. 22, 2010

(54) System for Reducing the Volume of a Battery Powered Device Using Distributed Battery Technology

(76) Inventor: Douglas Lopata, (US)

Correspondence Address: IP Legal Services, 1500 East Lancaster Avenue, Suite 200, P.O. Box 1027, Paoli, PA, 19301, US

(21) Appl. No.: 12/446,493

(22) PCT Filed: Nov. 29, 2006
(86) PCT No.: PCT/US06/45942

§ 371 Date: Apr. 21, 2009

(51) Int. Cl. H01M 6/42

(52) U.S. Cl. 429/160; 429/149

(57) ABSTRACT

A portable, battery-powered electrical device in which the battery is a distributed battery comprising a plurality of battery cells disposed throughout the device in spaces that would otherwise be unoccupied.

### FIELD OF THE INVENTION

The invention pertains to battery-powered electrical devices, particularly, portable electronic devices.

### BACKGROUND OF THE INVENTION

Generally in the electronics industry, and particularly in the wireless communication industry, there is a drive to reduce the size of electrical devices, and specifically portable electronic devices that are intended to be carried by individuals. Such devices include cellular telephones, walkie-talkies, AM/FM radios, portable CD players, portable audio tape players, portable digital music players of any kind, cameras, video cameras, portable DVD players, dictaphones, notebook computers, and GPS units.

FIG. 1 is a block diagram showing some of the major components of an exemplary cellular telephone 100. In the figures of this specification, data paths (e.g., electrical connection paths over which data and/or control signals travel) are denoted by dashed lines, while power supply paths (e.g., electrical connection paths over which power is provided to a component) are denoted by solid lines. Generally, wireless communication devices and other portable electronic devices are powered by a single, large battery pack 110 housed within the portable device 100 that powers all of the electrical components on the device through a power supply 112 which regulates the current and/or voltage supplied by the battery and directs the regulated power to the electrically powered components of the device 100. The battery pack often is a single unit and is rechargeable, as in a typical cellular telephone, or may comprise one or more disposable batteries, as in a typical portable CD player. The battery 110 may be removable or permanently installed. Generally, the device comprises a plurality of discrete electrical components that require power (i.e., electrical current/voltage) to operate. For instance, a cellular telephone comprises any number of components requiring electrical power, such as a digital signal processor (DSP) 114, a microphone 118, a speaker 116, an LCD display 122, a transceiver 124 (which is coupled to an antenna 126 that typically does not require its own power), a keypad 128, and memory 129. As another example (not shown), in the case of a portable digital audio player, it may comprise a hard drive, an LCD display, and a DSP, all of which require power.

Since individuals often carry a number of portable electronic devices in their pockets, purses, briefcases, bookbags, etc., there is a desire to minimize the size of these devices in order to make them more convenient to carry on the person.

While the electronics in such portable electronic devices typically are fairly densely packed (primarily for the purpose of minimizing the volume of the device), there is nevertheless a significant amount of empty space or air space in such devices. For instance, in cellular telephones, the keys of the keypad typically are hollow. Furthermore, there is often a significant amount of empty space behind an LCD display screen. Furthermore, in portable digital music players, there may be empty space in and around speakers, microphones, LCD displays, and the motors that rotate data storage discs, such as hard discs, DVDs, and CDs.

### SUMMARY OF THE INVENTION

A portable, battery-powered electrical device in which the battery is a distributed battery comprising a plurality of battery cells disposed throughout the device in spaces that would otherwise be unoccupied.

### BRIEF DESCRIPTION OF THE DRAWINGS

FIG. 1 is a block diagram illustrating some of the basic, major components of a conventional cellular telephone.

FIG. 2 is a block diagram illustrating some of the basic, major components of a cellular telephone in accordance with a first exemplary embodiment of the present invention.

FIG. 3 is a block diagram illustrating some of the basic, major components of a cellular telephone in accordance with a second exemplary embodiment of the present invention.

FIG. 4 is a block diagram illustrating some of the basic, major components of a cellular telephone in accordance with a third exemplary embodiment of the present invention.

FIGS. 5A and 5B are perspective views of a cellular telephone illustrating a feature of the present invention in accordance with another embodiment of the present invention.

### DETAILED DESCRIPTION OF THE INVENTION

In accordance with the principles of the present invention, an electrical device, and particularly, a portable electronic device, is made smaller by replacing a conventional battery, which consumes a large, unitary volume of space with a plurality of distributed battery cells distributed throughout the portable device in spaces that would otherwise be unoccupied (or occupied only by air). Distributed battery technology, such as polymorphic batteries that can be produced in virtually any shape and/or size, is used to advantage by placing such battery cells in any available space in the device. Each one of a plurality of distributed battery cells can be used individually to power one (or a few) components of the overall device. Preferably, a distributed battery cell is used to provide power to one or a few components that are physically close to it. Alternately, two or more distributed battery cells may be coupled in series or in parallel in order to provide a single power source with greater voltage and/or current than any one battery cell would provide individually. That collective voltage/current could be provided to power all of the electronics on the device. Alternately, any subset of the plurality of distributed batteries can be coupled in parallel or series with each other and used to power one or more components of the device, while other subsets or individual cells power other components of the device.

In a preferred embodiment, the battery cells are incorporated within, integral with, or adjacent to one or more of the mechanical components of the device, such as the keypad of a cellular telephone or a digital music player. Mechanical components (components having moving parts) such as keypads, speakers, microphones, and motors often have a significant amount of empty space in and around them. For instance, the keys of a typical keypad of a cellular telephone often are hollow. A small polymorphic battery cell could be incorporated in the air space behind each key of such a keypad and thus be integral with the keypad. Also, some electronic components also usually have some free space associated therewith. For instance, liquid crystal diode (LCD) displays often have significant air space behind the display, which can be filled with one or more polymorphic battery cells.

In one preferred embodiment, the battery cells are coupled to power only the component within which they are embodied. For instance, the cell or cells disposed in the keys could be used to power the keypad, including backlighting the keys or powering the key matrix. The battery cells in the keys could be coupled in parallel or in series to collectively provide a single power source for powering the entire keypad. Alternately, each individual cell can provide the power to each key in the keypad. In fact, any one or more of the distributed battery cells could be coupled to power any portion of the keypad, such as one row of the keys in the keypad. In a further alternative embodiment, one or more of the distributed battery cells disposed in the keypad could be used to power the keypad as well as other electronics in the immediate vicinity of the keypad.

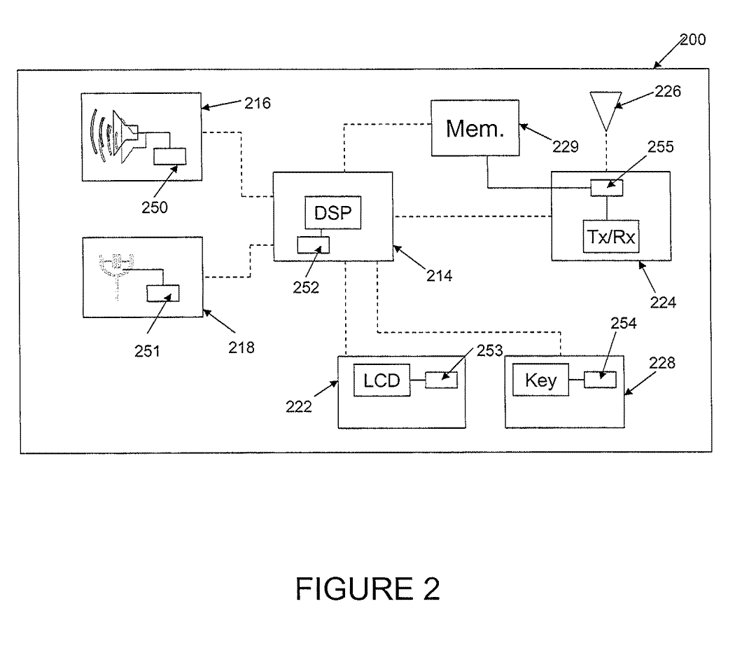

For instance, FIG. 2 is a block diagram illustrating an exemplary cellular telephone 200 in accordance with one particular embodiment of the invention. The telephone 200 includes typical electrical components such as a DSP 214, a speaker 216, a microphone 218, a display 222, a keypad 228, transmit/receive circuitry 224, memory 229 and an antenna 226. In this embodiment, a plurality of distributed battery cells 250, 251, 252, 253, 254, and 255 are distributed throughout the telephone 200. For instance, battery cell 250 is disposed in or near the speaker 216, battery cell 251 is disposed in or near the microphone 218, battery cell 252 is disposed in or near the DSP 214, battery cell 253 is disposed in or near the display 222, battery cell 254 is disposed in or near the keypad 228, and battery cell 255 is disposed in or near the transmit/receive circuitry 224. In this embodiment, each individual distributed battery cell provides power to the component in or near which it is disposed. For instance, battery cell 250 provides the power to the speaker 216, battery cell 251 provides the power to the microphone 218, battery cell 252 provides the power to the DSP 214, battery cell 253 provides the power to the display, and battery cell 254 provides the power to the keypad 228. Furthermore, battery cell 255 provides the power to the transmit/receive circuitry as well as to the memory 229, which memory preferably is disposed close to the transmit/receive circuitry.

If any circuitry for regulating the output of the battery or batteries is necessary, it may be incorporated in or near the area or component within which the battery(ies) it is regulating are disposed. Alternatively, one or more power supply regulators may be provided in the device and the output of the various batteries may be routed to the power supply regulator(s) and the output(s) of the regulator(s) provided back to the powered components.

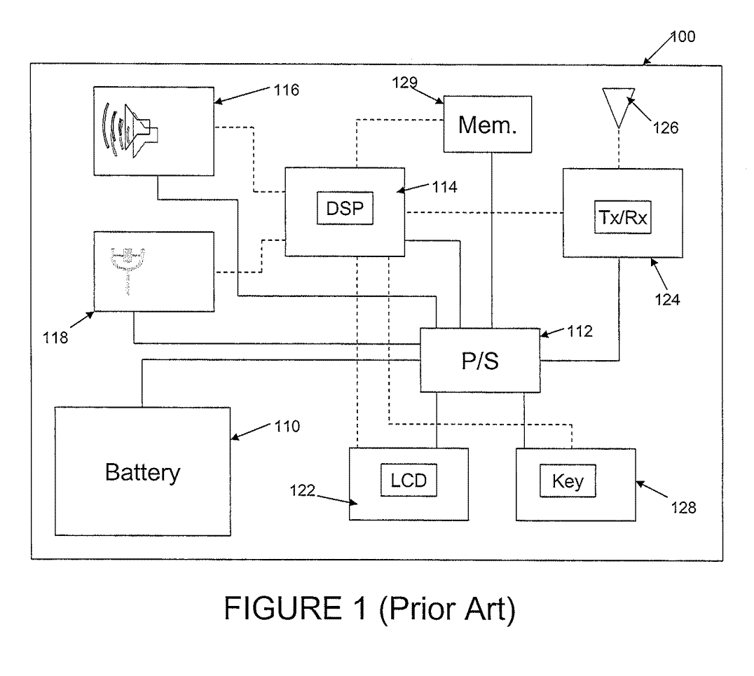

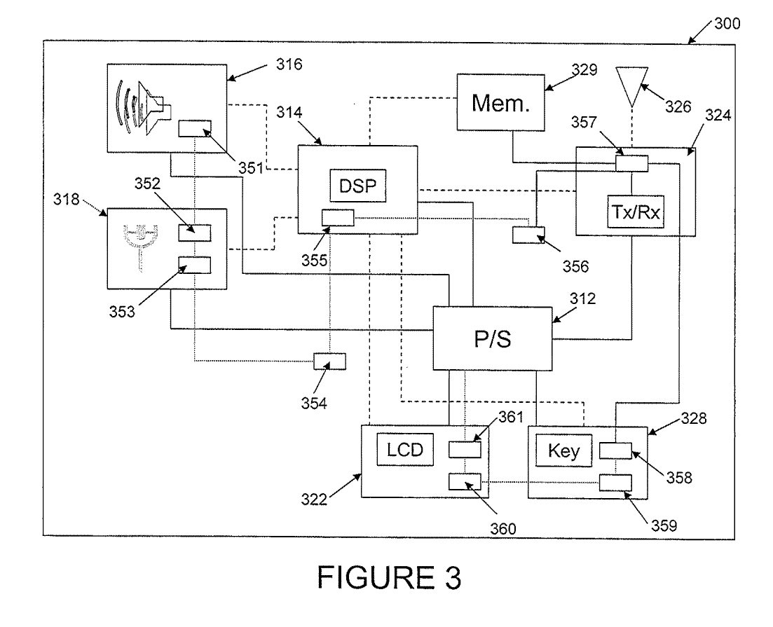

FIG. 3 illustrates another embodiment of the invention in which the distributed battery cells are coupled in series so as to collectively provide a greater voltage than any of the cells would provide individually. As in FIGS. 1 and 2, the solid lines represent paths providing power to the electrical components of the device and the dashed lines represent data or signal paths. However, in addition, the dotted lines represent the electrical connections through which the individual battery cells are coupled to each other in series.

In FIG. 3, the telephone 300 includes typical electrical components such as a DSP 314, a speaker 316, a microphone 318, a display 322, a keypad 328, transmit/receive circuitry 324, memory 329, and an antenna 326. In this embodiment, a plurality of distributed battery cells 351, 353, 353, 354, 355, 356, 357, 358, 359, 360, and 361 are distributed throughout the telephone 300. For instance, battery cell 351 is disposed in or near the speaker 316, battery cells 352 and 353 are disposed in or near the microphone 318, battery cell 354 is disposed in a miscellaneous area of the device, battery cell 355 is disposed in or near the DSP 314, battery cell 356 is disposed in another miscellaneous space within the telephone, battery cell 357 is disposed in or near the transmit/receive circuitry 324, battery cells 358 and 359 are disposed in or near the keypad 228, and battery cells 360 and 361 are disposed in or near the display 322. All of the battery cells are coupled in series as illustrated by the dotted lines and are connected to a power supply 312. The power supply 312 regulates the power provided by the series of battery cells and provides regulated power via the solid connection lines shown in the Figure to the various components of the device, such as speaker 316, microphone 318, DSP 314, display 322, keypad 328, transmit/receive circuitry 324, and memory 329.

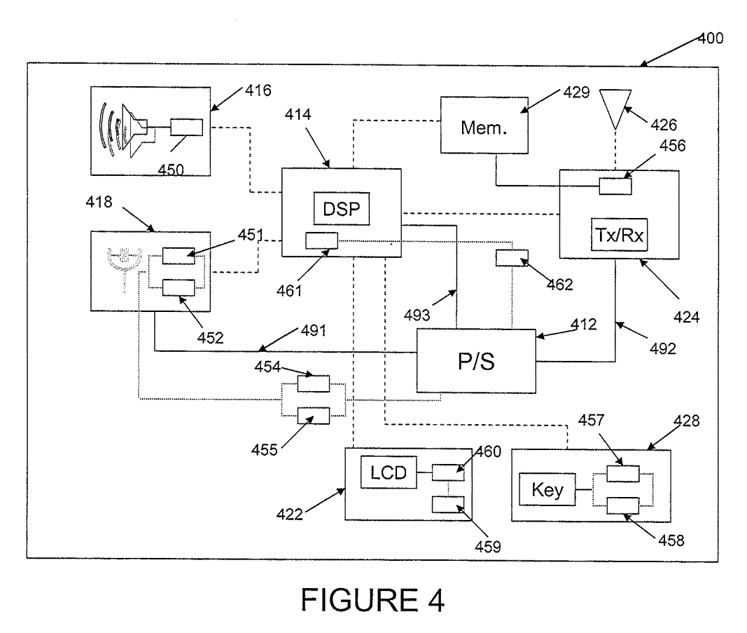

FIG. 4 illustrates yet another embodiment of the invention that is essentially a hybrid of the various embodiments described herein above. Particularly, in the FIG. 4 embodiment, some of the battery cells individually provide power to a single component of the device, some of the battery cells are coupled in series to collectively provide power to one or more components, some of the battery cells are coupled in parallel to collectively provide power to one or more components, and some of the battery cells are coupled together in a parallel and in series to provide power to one or more components.

In FIG. 4, the telephone 400 includes typical electrical components such as a DSP 414, a speaker 416, a microphone 418, a display 422, a keypad 428, transmit/receive circuitry 424, memory 429, and an antenna 426. In this embodiment, a plurality of distributed battery cells 450, 451, 452, 453, 454, 455, 456, 457, 458, 459, 460, and 461 are distributed throughout the telephone 400 in various different combinations and configurations. For instance, battery cell 450 is disposed in or near the speaker 414 and individually provides power to the speaker 414. Battery cells 451 and 452 are disposed in or near the microphone 418 and coupled in parallel with each other, while battery cells 453 and 454 are also coupled in parallel with each other in miscellaneous space in the telephone 400 and are further coupled in series with battery cells 451 and 452. The collective power output of these four battery cells is coupled to a power supply 412, which regulates the power supplied to it from battery cells 451, 452, 453, and 454 are provides regulated power to various components in the device 400, such as DSP 414, and microphone 418. Furthermore, battery cell 455 is disposed in or near the DSP and is coupled in series with battery cell 456 disposed in another miscellaneous space within the telephone 400. The output of battery cells 455 and 456 is coupled to power supply 412, which provides regulated power back to the microphone 418 via power path 491 as well as to other components on the device, such as transmit/receive circuitry 424 through power path 492. The battery cell 456 that is in or near transmit/receive circuitry 424 individually provides power to the memory 429. Battery, cells 457 and 458 disposed in keypad 428 are coupled in parallel and collectively supply power to the keypad 428, battery cells 459 and 460 are disposed in or near the display 424 and coupled in series and collectively provide power to the display.

Battery cell 461 disposed in or near DSP 414 and battery cell 462 disposed in a miscellaneous empty space of the telephone 400 are coupled in series, with their collective output fed to regulator 412. Regulator 412 regulates the power provided by series battery cells 461,462 and provides power to DSP 414 via power path 493.

The above-described embodiments are merely exemplary, illustrative embodiments. It should be understood that countless other configurations are possible.

Other areas of cellular telephones and other portable electronic devices that often have significant empty volume into which distributed battery cells may be disposed include the areas above and surrounding PCBs (printed circuit boards), particularly the space surrounding large analog circuit devices that may stick up from the PCB, such as capacitors and inductors. Other potential areas include the space surrounding motors for rotating hard drives, DVDs, and CDs in digital music players.

The invention can be embodied in essentially any device that is battery powered, but, of course, is particularly suitable for portable devices in which reduction of the volume (size) is a significant benefit. Such devices include cellular telephones, laptop computers, portable audio/video players, such as CD players, DVD players and MP3 digital players, cameras, video cameras, GPS (global positioning system) units, avalanche beacons, walkie-talkies, portable dictaphones and other portable recording devices, digital cameras, conventional film cameras, etc.

Polymorphic batteries are particularly suitable for use on the individual battery cells in the distributed battery technology described herein since such technology permits the manufacture of battery cells of very small size and of virtually any shape.

The size and/or shape of any given distributed battery cell typically may be dictated by the available volume within which it is to be disposed. In accordance with polymorphic battery technology, a series of battery shapes can be molded to fit each specific cavity space provided by the portable battery operated device. Polymorphic batteries are specifically suited to high-volume applications such as cell phones and MP3 players given that the large production unit volumes can facilitate better overall battery costs for the solution.

An example of a suitable polymorphic battery are Lithium Polymer Batteries (LPBs). LPBs are malleable and can be shaped as needed to fit many different space/volume requirements. LPBs are limited, however, to prismatic footprints and are not generally shaped as cylindrical, spherical, or other derivative shapes. LPBs are rechargeable batteries, so it is best suited to parallel or series connected distributed battery systems where a single battery charger can be used to recharge all cells. Given low-cost battery chargers, more than one battery charger could be integrated into the portable device to allow distributed charging of the polymorphic battery system. Manufacturers of LPBs include Sanyo Electric Co., LTD of Sumoto-City, Hyogo, Japan. Furthermore, Letourneau, J. et al, Progress in Lithium Polymer Battery Development for Telecommunication System, Telecommunications Energy Conference, 1998, INTELEC, Twentieth International, Oct. 4-8, 1998, pp. 656-662: San Francisco, Calif., USA, discloses salient features of LPB technology.

There are other suitable battery technologies that could serve the polymorphic battery applications and the LPB is offered as one example. It is also anticipated that current and future battery technologies will mature to the point where more sophisticated distributed battery systems can be designed to suit the needs of portable battery operated devices.

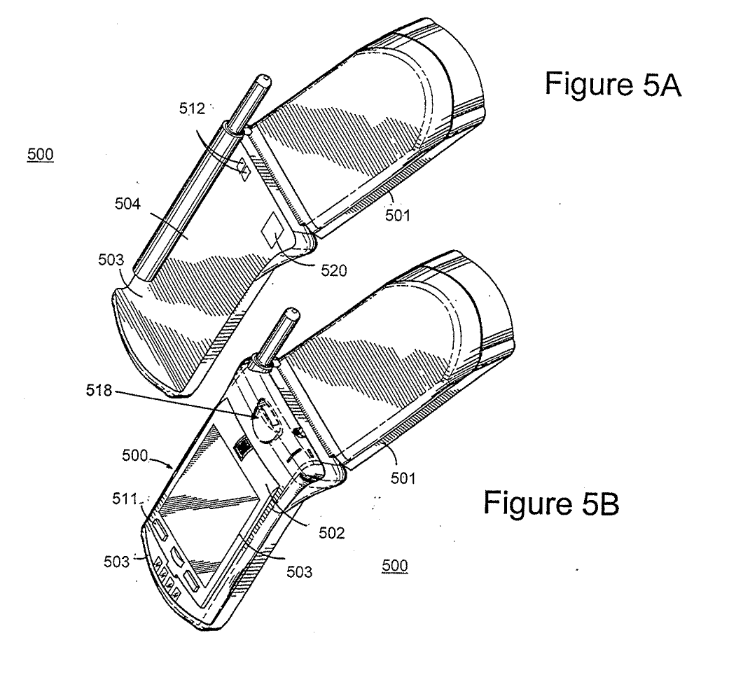

As previously noted, in a preferred embodiment of the Invention, different portions on the electronic device are individually powered by different cells of the distributed batteries. In such situations, it may be desirable to make the electronic device modular in the sense that different portions of it can be physically separated from the device so that they may be individually replaced. This may be particularly advantageous in situations where one cell of the distributed battery wears out or otherwise fails. Rather than having to repair or replace the entire device, only the portion of the device containing the failed battery cell may be replaced. For instance, FIGS. 5A and 5B illustrate a cellular telephone 500 of a conventional clamshell or flip-phone design comprising two halves 501,503 with a display portion 502, containing an LCD display 503 that is detachable from the body 504 of the telephone. Suitable electrical contacts 512 and a suitable mechanical attachment mechanism 516, such as a latch and catch mechanism 518,519, are Included to provide the necessary electrical and mechanical attachments. The detachable display portion 502 may or may not include some other components that receive power from distributed battery cells disposed within it, such as buttons 511.

Similarly, other components that contain one or more distributed battery cells, such as a keypad, microphone, or speaker also may be separable from the body of the telephone.

Having thus described a few particular embodiments of the invention, various alterations, modifications, and Improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A battery-powered electrical device comprising;
a plurality of discrete components including a plurality of electrically powered components; and
a distributed battery comprising a plurality of battery cells within said device coupled to provide power to said electrically powered components, wherein a first one of said battery cells is disposed within a volume of a first one of said discrete components and a second one of said battery cells is disposed in a second one of said discrete components.

2. The device of claim 1 wherein said first discrete component and said second discrete component are mechanical components.

3. The device of claim 1 wherein said device is a cellular telephone.

3a. The device of claim 1 wherein said first discrete component is a keypad.

4. The device of claim 1 wherein said first discrete component is a first keypad and said second mechanical component is a second keypad.

4a. The device of claim 1 wherein said first discrete component is an LCD display.

5. The device of claim 1 wherein a plurality of said battery cells are coupled in series to provide a greater voltage than is provided by said battery cells individually.

6. The device of claim 1 wherein a plurality of said battery cells is coupled in parallel to provide a greater current than is provided by said battery cells individually.

7. The device of claim 1 wherein said device is portable.

8. The device of claim 1 wherein said distributed battery cells comprise polymorphic battery cells.

9. The device of claim 1 wherein said plurality of electrically powered components comprises a first electrically powered component and a second electrically powered component, and wherein said first electrically powered component is coupled to receive power from a first subset of said battery cells and said second electrically powered component is coupled to receive power from a second subset of said battery cells.

10. The device of claim 9 wherein said first subset of said battery cells and said second subset of said battery cells are non-overlapping subsets.

11. The device of claim 10 wherein said first subset of battery cells is disposed more proximate said first electrical component than said second electrical component and said second subset of battery cells is disposed more proximate said second electrical component than said first electrical component.

12. The device of claim 11 wherein said first subset of battery cells comprises battery cells coupled in series with each other and said second subset of battery cells comprises battery cells coupled in series with each other and wherein said first subset of battery cells and said second subset of battery cells are independent of each other.

13. The device of claim 9 wherein said first mechanical component is physically separable from said second mechanical component.

14. The device of claim 1 wherein said device is modular, comprising at least one portion that is physically separable from said device, said one portion containing a subset of said battery cells.

15. The device of claim 1 wherein said first one of said battery cells powers said first one of said discrete components and does not power said second one of said discrete components and wherein said second one of said battery cells powers said second one of said discrete components and does not power said second one of said discrete components.

16. A battery-powered electrical device comprising;
a plurality of discrete components including a plurality of electrically powered components; and
a distributed battery comprising a plurality of battery cells within said device coupled to provide power to said electrically powered components, wherein a first one of said battery cells is integral with a first one of said discrete components and a second one of said battery cells is integral with a second one of said discrete components.
